(19) United States
(12) Patent Application Publication
(10) Pub. No.: US 2013/0268221 A1
(43) Pub. Date: Oct. 10, 2013

(54) ON-CHIP INTEGRATED CIRCUIT POWER MEASUREMENT CELL

(71) Applicants: Brian G. Reise, Colorado Springs, CO (US); Patrick A. Oostenrijk, Colorado Springs, CO (US)

(72) Inventors: Brian G. Reise, Colorado Springs, CO (US); Patrick A. Oostenrijk, Colorado Springs, CO (US)

(73) Assignee: LSI CORPORATION, Milpitas, CA (US)

(21) Appl. No.: 13/439,660

(22) Filed: Apr. 4, 2012

(51) Int. Cl. G06F 19/00

(52) U.S. Cl. 702/61

(57) ABSTRACT

A power measurement cell, or group of power measurement cells, for the calculation of the power consumption of one or more electrical signals, as well as monitoring electrical signals in an integrated circuit, are disclosed. Further, super cells for the automation of specialized functions associated with the calculation of power consumption of one or more electrical signals are also disclosed. Methods associated with the use of the one or more power measurement cells and for the use of super cells for the calculation of the power consumption of one or more electrical signals are also described.

### BACKGROUND

Integrated circuits have become an inseparable feature of today's electrical devices due to the ability of an integrated circuit to provide a variety of operations for electrical devices at a relatively low cost. The ability to test the power consumption of an integrated circuit is an integral part of the development and maintenance of an integrated circuit device. The measurement of the power consumption of an integrated circuit allows a user to identify the health of an integrated circuit, test a device's parameters, as well as provide a variety of other aspects of an integrated circuit.

### SUMMARY

An embodiment of the present invention may comprise a method for measuring the power consumption of an electrical signal of an integrated circuit comprising: connecting a power measurement cell to an integrated circuit; measuring the voltage of one electrical signal of the integrated circuit; measuring a current draw of the electrical signal of the integrated circuit; calculating the power consumption of the electrical signal of the integrated circuit based on the voltage and the current draw of the electrical signal; and communicating the power consumption of the electrical signal of the integrated circuit to a host.

An embodiment of the present invention may further comprise a power measurement cell for the measurement of the power consumption of an electrical signal of an integrated circuit comprising: an internal interface bus that is connected to the integrated circuit; a voltage logic cell that is connected to the electrical signal from the integrated circuit; at least one data storage register that is connected to the voltage logic cell; at least one control register that is connected to the voltage logic cell; a current measurement cell that is connected to the electrical signal from the integrated circuit; at least one data storage register that is connected to the current measurement cell; a power calculation logic cell, where the power calculation logic cell is connected to the data storage register from the voltage logic cell and to the data storage register from the current measurement cell; at least one data storage register that is connected to the power calculation logic cell; and a data buffer that is connected to the at least one data storage register that is connected to the power calculation logic cell.

### BRIEF DESCRIPTION OF THE DRAWINGS

FIG. 1 is a block diagram of a power measurement cell.

FIG. 2 is a block diagram of a super cell.

FIG. 3 is a block diagram of a series of power measurement cells with a super cell.

FIG. 4 is a block diagram of a series of electrical signals measured by a series of power measurement cells.

FIG. 5 is a block diagram of a package of power measurement cells and a super cell embedded in an integrated circuit.

FIG. 6 is a diagram of a power measurement cell embedded in an integrated circuit.

FIG. 7 is a diagram of a power measurement cell located externally to an integrated circuit.

FIG. 8 is a diagram of a power measurement cell with a super cell embedded within an integrated circuit.

FIG. 9 is a diagram of a power measurement cell with a super cell located externally to an integrated circuit.

FIG. 10 is a diagram of a series of power measurement cells.

FIG. 11 is a diagram of a series of power measurement cells with a super cell.

FIG. 12 is a flow diagram of a process for a power measurement cell to determine the power consumption of an electrical signal of an integrated circuit.

FIG. 13 is a flow diagram of a process of a super cell to gather information from one or more power measurement cells.

### DETAILED DESCRIPTION OF THE EMBODIMENTS

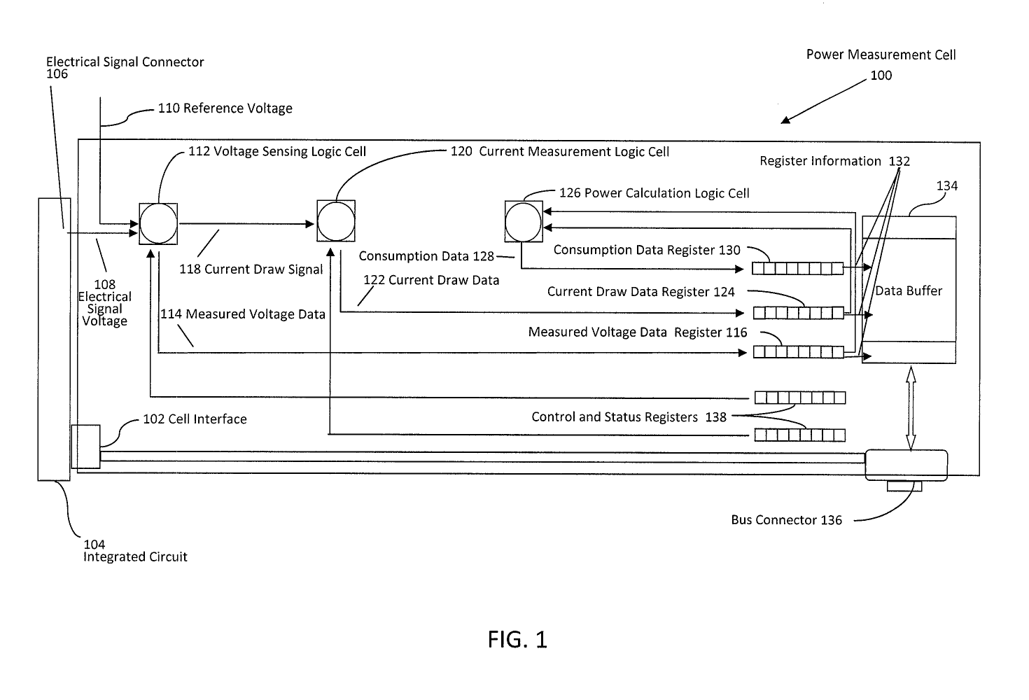

FIG. 1 is a block diagram of a power measurement cell 100 for the measurement of the power consumption of an electrical signal of an integrated circuit. As illustrated in FIG. 1, a power measurement cell 100 interfaces with an integrated circuit 104 using a cell interface 102, such as an inter-integrated circuit (I2C) Ethernet, serial or a peripheral local bus (PLB). Once the power measurement cell 100 has interfaced with the integrated circuit 104, the power measurement cell 100 conducts all of the necessary steps for the measurement of the power Consumption of the electrical signal of the integrated circuit are conducted within the power measurement cell, where the term electrical signal may include a power plane, a voltage potential or current flow. The electrical signal voltage 108 of the integrated circuit 104 is transmitted by the electrical signal connector 106 from the integrated circuit 104 to the voltage sensing logic cell 112. The voltage sensing logic cell 112 measures the electrical signal voltage 108 of the integrated circuit 104 to produce measured voltage data 114 using an analog to digital converter (ADC). A reference voltage 110 provides a reference voltage signal for the calculation of the power consumption of the integrated circuit 104. The measured voltage data 114 from the voltage sensing logic cell 112 is sent and stored in a measured voltage data register 116. Current draw signal 118 of the electrical signal of the integrated circuit 104 is measured using a current measurement logic cell 120 to produce current draw data 122. The current draw data 122 from the current measurement logic cell 120 is stored in a current draw data register 124. The voltage data and the current draw data in the measured voltage data register 116 and the current draw data register 124 is sent to a power calculation logic cell 126. The power consumption of the electrical signal of the integrated circuit 104 is calculated in the power calculation logic cell 126 and the power consumption data 128 is sent to and stored in a consumption data register 130. Register information in the consumption data register 130, measured voltage data register 116 or the current draw data register 124 is sent 132 to a data buffer 134 where the register information can be stored for access through a bus connector 136 by an external host (an example may include a laptop computer or PCIe (Peripheral Component Interconnect Express)) or other specific test debug ports (such as an I2C or universal asynchronous receiver/transmitter (UART)). The determination of which register information from the consumption data register 130, measured voltage data register 116 or the current draw data register 124 to store in the data buffer 134 could be controlled through the control and status registers 138. Accessing the register information might be done by reading from the register access port such as the data buffer 134. The register access port can be associated with any type of external host. The data buffer 134 can hold a certain number of samples of data from the register information and the data buffer 134 can be programmed to produce an output signal or set a flag when it reaches a certain number of entries. Data in the data buffer 134 can be accessed almost immediately as the user adjusts various parameters of the integrated circuit 104 by turning power consuming features on or off. This gives the user the flexibility to validate certain features and their impact on the power consumption of the integrated circuit 104. A bus connector 136 provides external control access over the power measurement cell 100. An external host, such as a laptop computer, can control the functionality of the integrated circuit 104, with which the power measurement cell 100 is interfaced, and instruct the power measurement cell 100 to perform certain measurements. Control and status registers 138 are programmed to provide various commands and status controls for the voltage sensing logic cell 112 and the current measuring logic cell 120. The control and status registers 138 allow for the power measurement cell 100 to be controlled and programmed all within the power measurement cell. Through control and status registers 138, the register information within data buffer 134 can be cleared.

Traditional integrated circuit chip power measurement methods are implemented on the system board where the integrated circuit is mounted. Reference resistors are instantiated to isolate the integrated circuit electrical signal from the main electrical signal providing the same reference voltage level. The purpose of the reference resistors is to provide a physical contact point to measure the actual voltage across the physical contact point so that the supply current can be calculated as Iref=(Vdd1_Main−Vdd1_Chip)/Rref)). Then, using this calculated current value, the power drawn from the respective power supply or source can be calculated with the equation Power=Iref×Vdd1_Main. Unlike traditional integrated circuit power measurement methods, the power measurement cell 100, shown in FIG. 1, allows for the voltage measurement and power calculation of the electrical signal of an integrated circuit 104 to be done internally within the power measurement cell using the voltage sensing logic cell 112, current measurement logic cell 120, and the power calculation logic cell 126.

As shown in FIG. 1, the power measurement cell 100 can operate on a single electrical signal to measure voltage potential or current flow, an entire power rail, individual power planes or isolated logic blocks, such as analog processor cores, and memory. Furthermore, the power measurement cell 100 can be connected with other power measurement cells, through a cell interface or bus connector 136, to provide more inputs. A processor external to the power measurement cell 100 can request any information from the cell through the cell interface or bus connector 136.

Because the power measurement cell 100 is completely self-contained, the power measurement cell 100 may be embedded within the integrated circuit 104 or external to the integrated circuit 104. As all of the blocks necessary for the measurement of the power consumption of the electrical signal or monitoring electrical signals are housed in the power measurement cell 100, the need for additional external test points, fixtures, hardware and test equipment is eliminated and the procedures for the set-up for performing power measurement tests are eliminated.

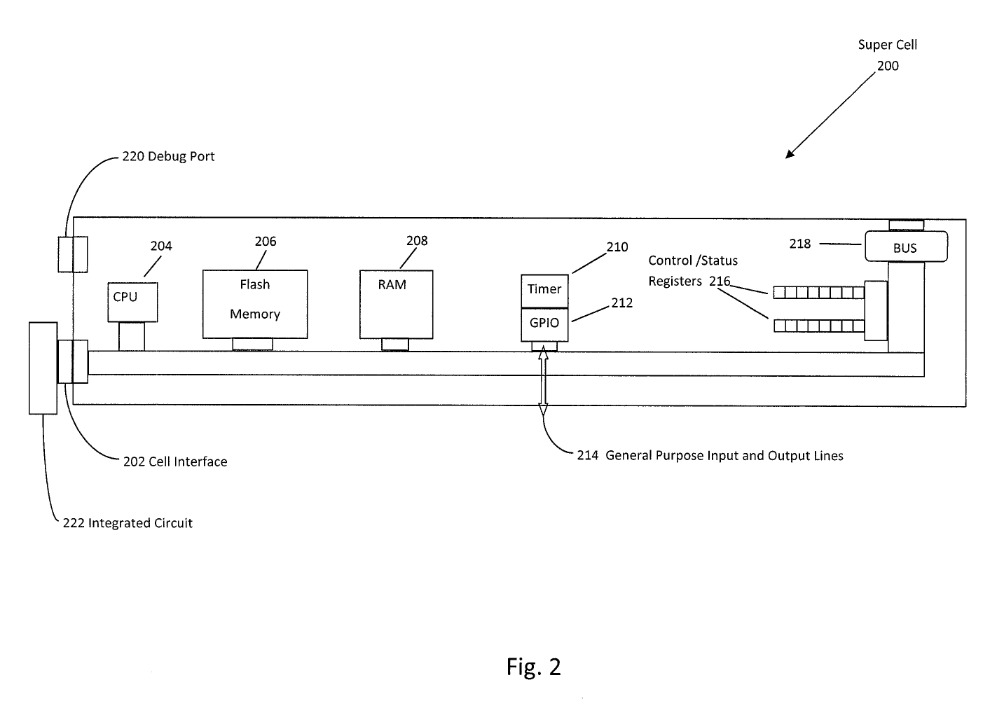

FIG. 2 is a block diagram of a super cell 200. As shown in FIG. 2, the super cell 200 interfaces with an integrated circuit 222 using a cell interface 202, such as a local interfacing bus. A central processing unit (“CPU”) 204 provides the super cell with intelligent input/output by taking over all power measurement control of one or more power measurement cells, such as the power measurement cell 100 of FIG. 1, interfacing with the super cell 200 from an embedded or external (Host) processor. This dedicated CPU 204 frees up bandwidth for an embedded or external processor to execute higher priority tasks, such as data management, interrupt control, as well as other tasks. A CPU 204 controls instruction execution of a program contained in super cell's 200 flash memory 206. The flash memory 206 contains the parameters for the CPU 204 and the appropriate instructions or the specialized functions of the power measurement cells interfaced with the super cell 200. The flash memory 206 contains a user-configurable program that allows an external host to change automated functionality. For example, instead of taking measurements from a series of one or more power measurement cells once every 5 minutes, an external host can change the program in the flash memory 206 to take measurements every 30 seconds. If one of the measurements exceeds a set boundary, then a general purpose input/output (“GPIO”) 212 pin can be toggled to indicate a certain condition. The program in flash memory 206 can support a multitude of functionality, including but not limited to instruct a series of single power measurement cells with a single command or send individual commands to each single power measurement cell or instruct a series of power measurement cells to reset or initialize itself with certain values. The flash memory 206 can be updated through the power measurement bus connector or cell interface 218 and can control the general purpose input/output 214 to power an external light-emitting diode (“LED”) as a status indication, or even communicate with another integrated circuit. Once the flash memory 206 is programmed by an external host, the flash memory 206 does not need to be reprogrammed again, unless there is a change in the measurement process.

As further shown in FIG. 2, a random access memory block (“RAM”) 208 is provided where the data from the power measurement cell is stored. The RAM 208 stores log information, program test results, or holds variables, such as counters. The CPU 204 in the super cell 200 interfaces with the flash memory 206, as well as the RAM 208, through a native, internal bus. For long term use, the collected data in the super cell 200 can be offloaded onto an external non-volatile computer memory (“NVSRAM”) storage device that can be connected to the super cell's GPIO 212 input and output lines 214. The GPIO 212 allows information to be passed out of the super cell 200 by means of generic input/output lines 214 that allow functions, such as status information, to be passed out of the super cell 200 and be presented to either the integrated circuit's 222 external pins or other integrated circuit internal logic blocks for monitoring purposes. A timer 210 is provided in the super cell 200 for use in assisting the CPU 204 to take periodic measurements of the power consumption and electrical signals, as measured by a power measurement cell. The timer 210 can be programmed with a certain resolution to take periodic measurements of the power consumption of the one or more electrical signals that are being monitored and measured by power measurement cells. The timer logic block 210 can control sampling and polling intervals. Control and status registers 216 allow input groups to be assigned to the timer 210. A special divider register may also be incorporated into the super cell 200 to specify a number of timing resolutions, so that groups can be triggered at different periodic intervals. Control and status registers 216 can contain configurable information, such as how individual power measurement cells are linked, presented as a group, timer interval values, and how the GPIO 212 pins are configured. A second local interfacing bus 218 is provided which allows the super cell 200 to communicate with one or more power measurement cells. A debug port 220 provides a second means of access to the super cell 200.

The super cell 200 is able to relieve an external host core processor of any performance impact that results from taking periodic measurements. By combining more advanced and autonomous features of a super cell 200, the expandability of the design becomes modular. The functionality contained within the super cell 200 allows for independent operation and control by off-loading tasks that would normally be performed by either an embedded (on-chip) processor or an external host processor.

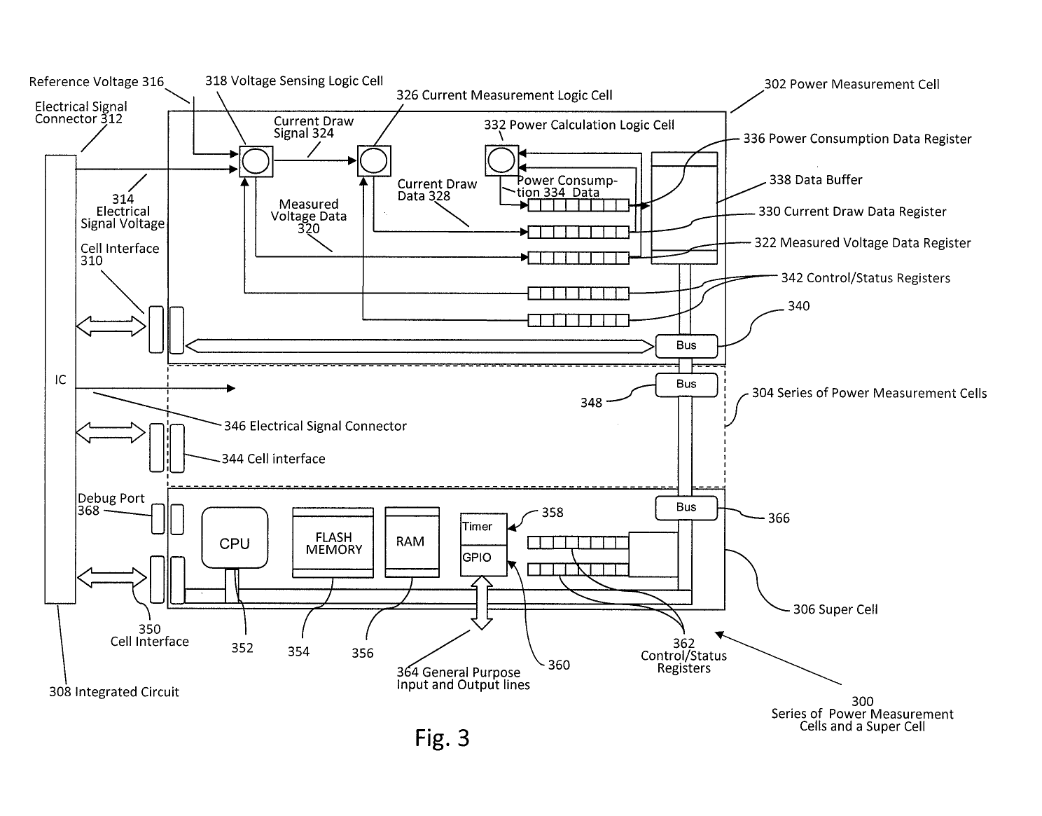

FIG. 3 is a block diagram of a series of power measurement cells chained to a super cell 300. As shown in FIG. 3, a first power measurement cell 302, 100 as shown in FIG. 1, is chained to a series of one or more power measurement cells 304 by a local interface bus 340. The series of power measurement cells 304 is also chained to a super cell 306, 200 as shown in FIG. 2, by means of a local interface bus 348. The series of single power measurement cells 302 and 304 can be chained together and either controlled by a single super cell 306 or controlled by an external host. The first power measurement cell 302 interfaces with an integrated circuit 308 using a cell interface 310, such as a local interfacing bus. Once the power measurement cell 302 has interfaced with the integrated circuit 308, the electrical signal voltage 314 of the integrated circuit 308 is transmitted by the electrical signal connector 312 from the integrated circuit 308 to the voltage sensing logic cell 318. The voltage sensing logic cell 318 measures the electrical signal voltage 314 of the integrated circuit 308 to produce measured voltage data 320 using an analog to digital converter (ADC). A reference voltage 316 provides a reference voltage signal for the calculation of the power consumption of the integrated circuit 308. The measured voltage data 320 from the voltage sensing logic cell 318 is sent and stored in a measured voltage data register 322. Current draw signal 324 of the electrical signal of the integrated circuit 308 is measured using a current measurement logic cell 326 to produce current draw data 328. The current draw data 328 from the current measurement logic cell 326 is stored in a current draw data register 330. The measured voltage data 320 and the current draw data 328 in the measured voltage data register 322 and the current draw data register 330 is sent to a power calculation logic cell 332. The power consumption of the electrical signal of the integrated circuit 308 is calculated in the power calculation logic cell 332 and the power consumption data 334 is stored in a consumption data register 336. The register information in the measured voltage data register 322, current draw data register 330 or the consumption data register 336 is sent to a data buffer 338 where the register information can be stored for access from an external host (an example may include a laptop computer or PCIe (Peripheral Component Interconnect Express)) or other specific test debug ports (such as an I2C or universal asynchronous receiver/transmitter (UART)). Control and status registers 342 are programmed to provide various commands and status controls for the voltage sensing logic cell 318 and the current measuring logic cell 326 as well as what register information to store in the data buffer 338. One or more power measurement cells 304 interfaces with the first power measurement cell 302 by means of a local interfacing bus 340. The one or more power measurement cells 304 contains all of power measurement components provided in the first power measurement cell 302. The one or more power measurement cells 304 interface with the integrated circuit 308 by means of a cell interface, such as a local interface bus 344. The one or more electrical signal voltages of the integrated circuit 308 are transmitted by one or more electrical signal connectors 346 from the integrated circuit 308. The register information of the one or more electrical signals of the integrated circuit 308 measured by the one or more power measurement cells 304 can be accessed by the super cell 306 by means of a local interface bus 366. The local interface bus 366 of the super cell 306 will disable each power measurement cell's 302 and 304 individual interface bus 340 and 348. The super cell 306 interfaces with the integrated circuit 308 by means of a cell interface such as a local interface bus 350. The super cell 306 is interfaced with an integrated circuit 308 in order for the super cell 306 to provide additional features that allow more autonomous operation of one or more power measurement cells 302 and 304. A CPU 352 controls the execution of a program contained in flash memory 354. The flash memory provides the parameters to the CPU 352 for the appropriate instructions or the specialized functions of the power measurements cells 302 and 304. The CPU 352 can manage data traffic for hard drives and therefore prevent a performance impact on internal CPUs of the integrated circuit 308. In case of validation tasks, an external host may also connect to one or more power measurement cells 302 and 304 and perform specific tests to obtain measurements and statistics for certain data traffic conditions. A RAM block 356 is provided where the data from both power measurement cells 302 and 304 can be stored. A timer 358 is provided in the super cell 306 for use in the periodic measurement of the power consumption of the electrical signals of the integrated circuit 308, as well as a GPIO block 360, that allows information to be passed out of the super cell 306 to be accessed by an external host by means of generic input/output lines 364. Control and status registers 362 provide additional programming aspects for the super cell 306. A debug port 368 provides a second means of access to the super cell 306.

Additional power measurement cells can be chained to the first power measurement cell 302 to enable additional electrical signals of an integrated circuit 308 to be measured with each additional power measurement cell. Each additional power measurement cell is able to interface with the previous power measurement cell by using a local interfacing bus to chain each power measurement cell together. The new power measurement cell will also interface with the integrated circuit 308 using a separate cell interface, such as a local interfacing bus.

Each bus interface 340, 348 and 366 can be bonded out so that when a super cell 306 and series of single power measurement cells 302 and 304 embedded in an integrated circuit, a manufacturer could chain one or more separately packaged single measurement cells external to the integrated circuit as well. The ability to have a series of one or more single power measurement cells and a super cell embedded within an integrated circuit as well as a series of one or more power measurement cells external to the integrated circuit allows an external host to monitor an aspect of an appliance or other unit in which the integrated circuit is housed by simply interfacing with the one or more external single power measurement cells chained to the one or more single power measurement cells internal to the integrated circuit.

As shown in FIG. 3, by integrating all of the power measurement features into a standalone integrated circuit package, power measurement cells 302, 304 and the super cell 306 can be expanded to monitor any number of devices on a system board, such as power regulators, memories, and other input/output chips. An integrated circuit 308 housing a series of power measurement cells 302 and 304 and a super cell 306 may support a variety of industry standard external interfaces to communicate with other devices on the board, such as I2C, USB, JTAG, and UART.

Because the power measurement cell is designed as a library component, it can also be packaged by itself and provided to manufacturers as a means to monitor anything in a system, such as temperature sensors, power supply sensors, and other sensors. If the super cell is attached to one or more single power measurement cells, the unit can operate independently from any other processor and relieve that processor from any major performance impact.

The power measurement cell may be portable and packaged individually, or as a series of power measurement cells, that will allow users to add power measurement cells to integrated circuits as needed to monitor voltage, power consumption and power levels. A portable device, such as a laptop computer, will also be able to interface with the one or more power measurement cells and allow a user to qualify hardware before it is used, which will save time on troubleshooting issues due to failing hardware. In the field, an external host can access power measurement cells to assist customers with finding the root cause for certain issues. A portable device that can interface with the power measurement cell eliminates the need to maintain an entire setup in working condition and eliminates potential problems introduced by other hardware components.

Power measurement cells can be programmed to continuously monitor certain inputs, or take periodic snapshots, over a specified period of time and calculate an average. An example may be to monitor and adjust power consumption levels in both normal integrated circuit operation and power management modes. Power measurement cells may have inputs that can be controlled individually or as a group consisting of one or more inputs. A group of power measurement cells can be assigned a normal operating range over which an average can be calculated. There may also be special registers to monitor outliers, such as voltage spikes or dips. These special registers are associated with count registers so that outliers and the number of samples can be counted. The super cell can be programmed to output a signal if a count is reached or an outlier condition is observed. This can provide operational status information.

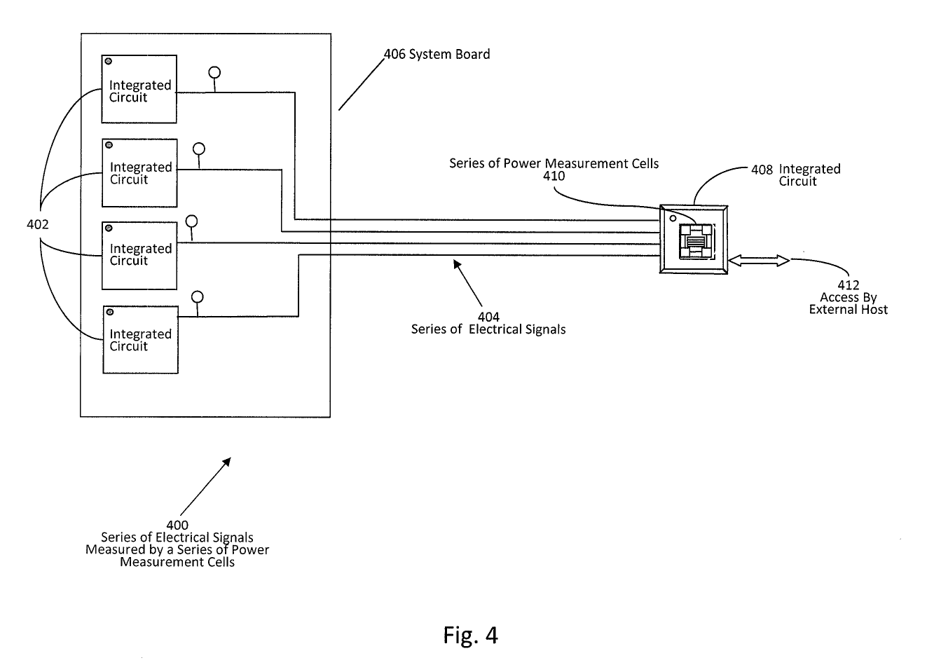

FIG. 4 is a block diagram of a series of electrical signals measured by a series of power measurement cells 400. As shown in FIG. 4, a series of electrical signals 404, from a series of integrated circuits 402, are shown on a system board 406, such as power regulators and other input/output chips. A series of power measurement cells 410 are shown embedded in an integrated circuit 408. The series of power measurement cells 410 measure the power consumption of each electrical signal 404 of each integrated circuit 402. The data regarding the power consumption of each electrical signal 404 of each integrated circuit 402 can be accessed from the series of four power measurement cells by an external host 412.

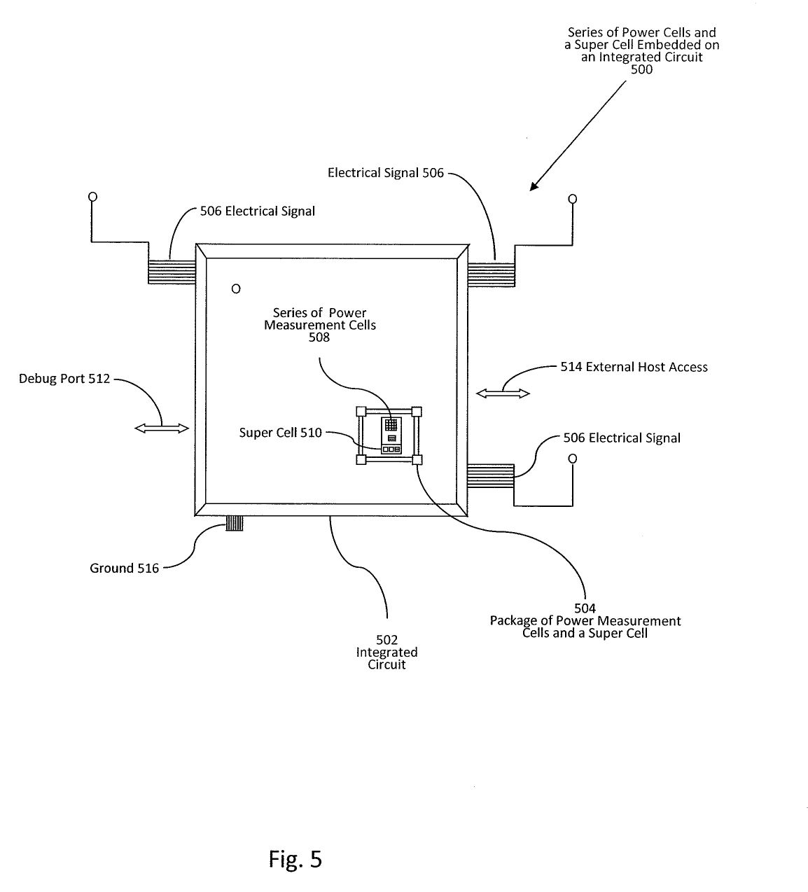

FIG. 5 is a block diagram of a package of power measurement cells and a super cell embedded on an integrated circuit 500. As shown in FIG. 5, a package of power measurement cells and a super cell 504, containing a series of power measurement cells 508 and a super cell 510, are embedded on an integrated circuit 502. The integrated circuit 502 has three electrical signals 506 from which the series of power measurement cells 508 and super cell 510 is able to measure a series of electrical signals 506. An external host is able to access 514 the data from the group of cells by means of an internal interface bus and a debug port 512 provides a secondary means of accessing the group cell. A voltage ground 516 for the integrated circuit 502 is also shown.

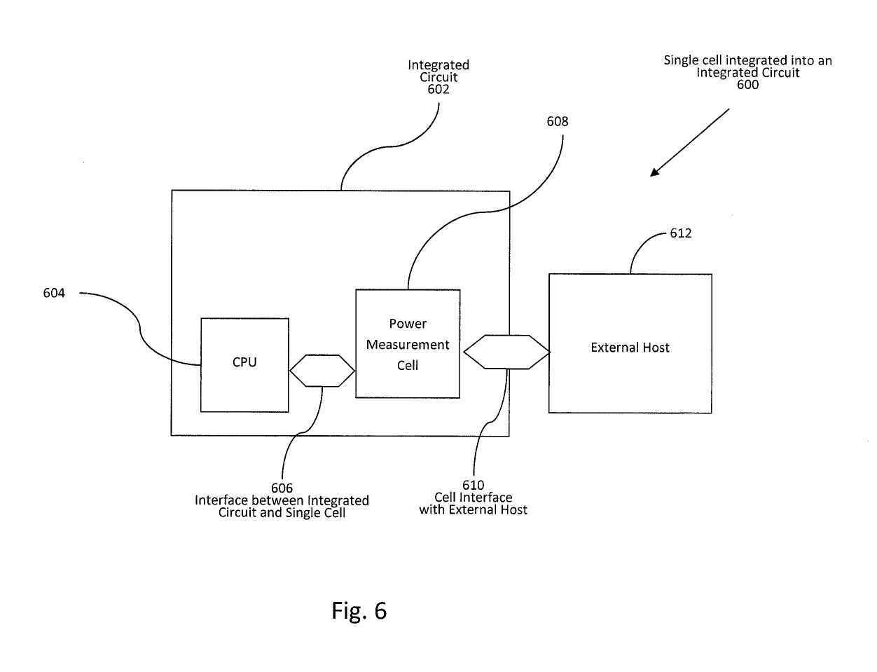

FIG. 6 is a diagram of a single power measurement cell embedded into an integrated circuit 600. As shown in FIG. 6, an integrated circuit 602 with a CPU 604 is interfacing 606 with a power measurement cell 608, which is embedded in the integrated circuit 602. The power measurement cell 608 is monitoring an electrical signal inside the integrated circuit 602. In this example, the integrated circuit 602 is a special micro-controller with a CPU 604, such as an ARM processor. The CPU 604 accesses its own external flash memory that contains firmware to be executed. The firmware has functionality that can communicate with one or more power measurement cells and request measurements at a certain periodic interval. An external host 612 can connect 610 to the power measurement cell 608 and perform specific tests to obtain measurements and statistics for certain data traffic conditions.

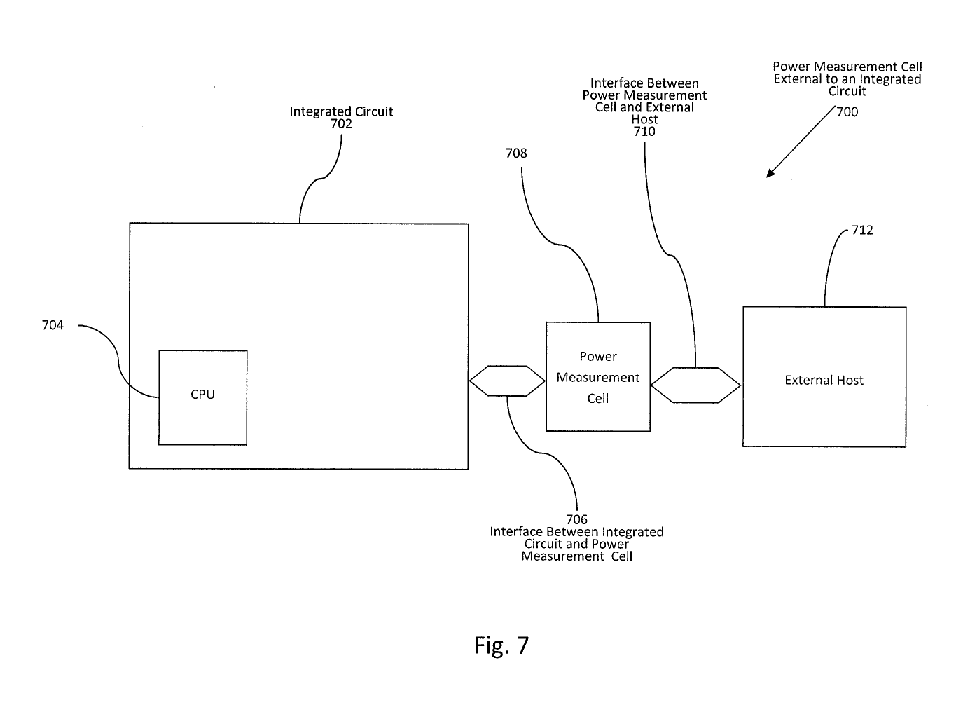

FIG. 7 is a diagram of a power measurement cell external to an integrated circuit 700. As shown in FIG. 7, a power measurement cell 708 is monitoring an electrical signal or power plane from an integrated circuit 702. In this example, the integrated circuit 702 is a motherboard with a CPU 704. The power measurement cell 708 interfaces 706 with the integrated circuit 702 and the CPU 704 requests the power measurement cell 708 to monitor the integrated circuit 702, such as taking a temperature reading. An external host 712 can interface 710 with the power measurement cell 708 by means of a laptop computer or other device in order to check the temperature of the system.

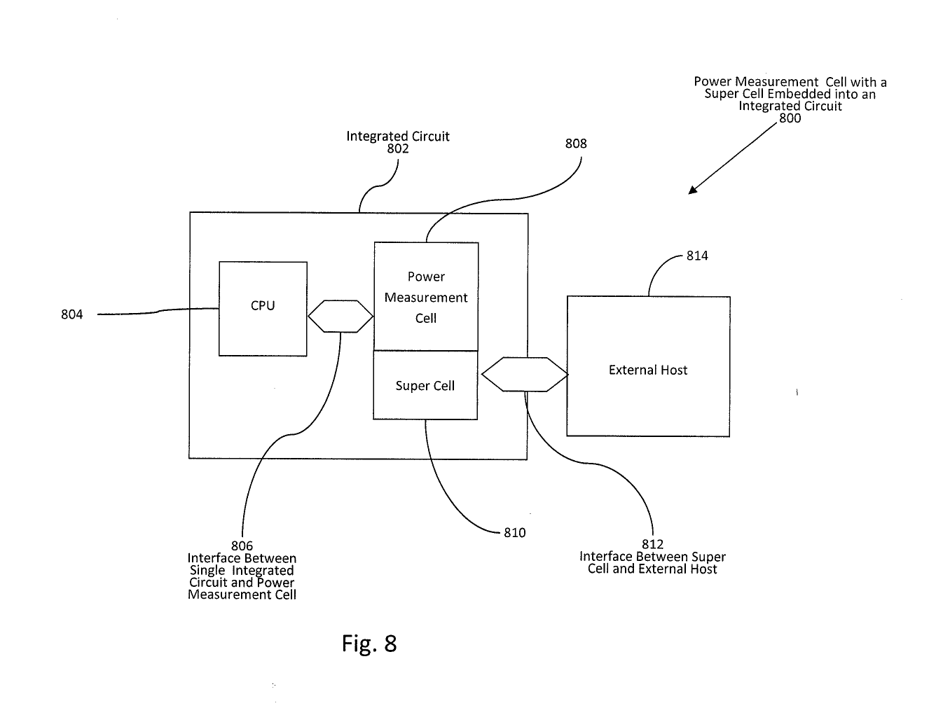

FIG. 8 is a diagram of a power measurement cell with a super cell embedded into an integrated circuit 800. As shown in FIG. 8, an external host 814 is able to interface 812 with the super cell 810, such as the external host 814 uploading a monitoring program to the super cell's 810 flash memory that can run independently of the integrated circuit's 802 CPU 804. The integrated circuit 802 interfaces 806 with a single power measurement cell 808, where the single power measurement cell 808 is chained to the super cell 810. The super cell 810 interfaces 812 with an external host 814, which also allows the external host 814 to obtain information, such as status reports at any time.

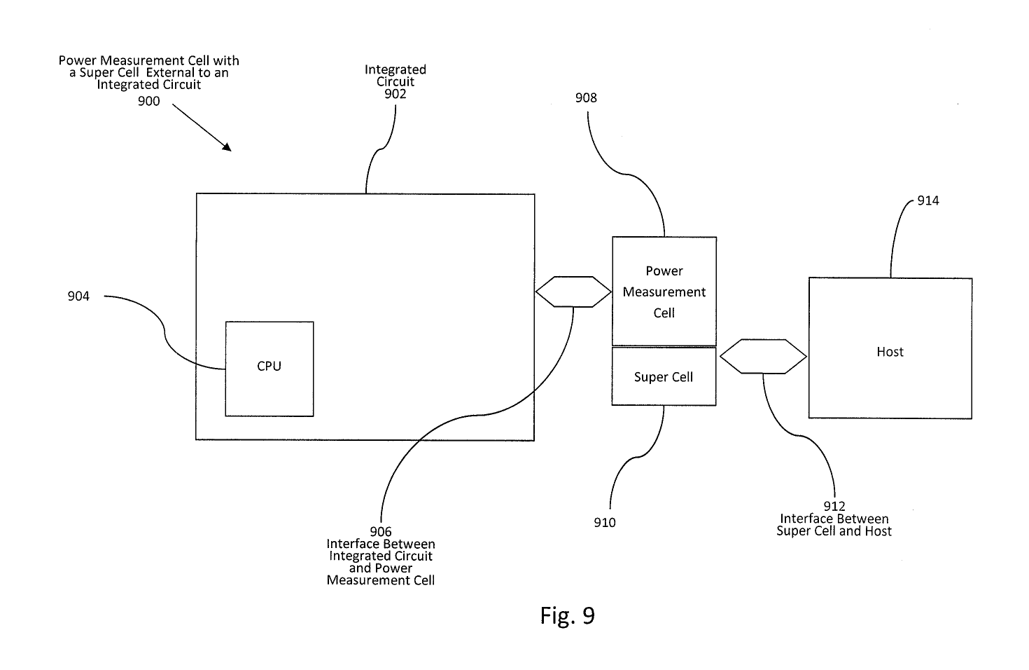

FIG. 9 is a diagram of a power measurement cell with a super cell located externally to an integrated circuit 900. As shown in FIG. 9, an integrated circuit 902, such as a motherboard, has a CPU 904. A power measurement cell 908 and a super cell 910 are separate units from the integrated circuit 902. Once the interface 906 between the integrated circuit 902 and the power measurement cell 908 is initialized, the super cell 910 is able to control the power measurement cell 908 and monitor the electrical signal of the integrated circuit 902, such as the ventilation system of an appliance the integrated circuit is housed within. An external host 914, such as a laptop, is able to interface 912 with the super cell 910 and monitor the ventilation performance of the appliance through the integrated circuit 902.

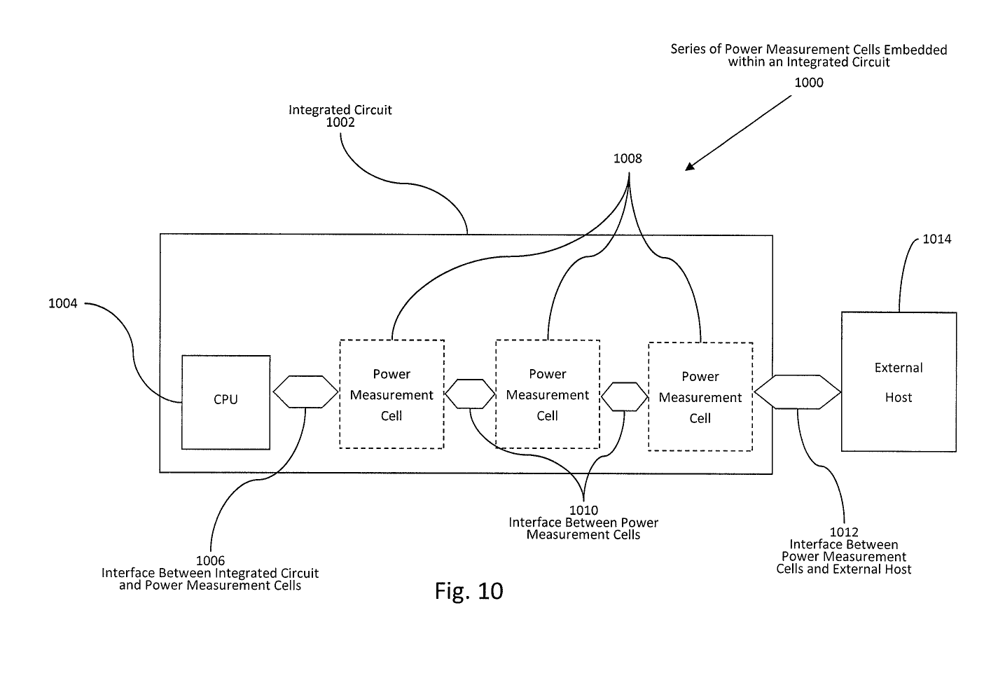

FIG. 10 is a diagram of a series of power measurement cells embedded within an integrated circuit 1000. As shown in FIG. 10, an integrated circuit 1002 with a CPU 1004 interfaces 1006 with a series of power measurement cells 1008. Each power measurement cell 1008 monitors an electrical signal of the integrated circuit 1002, with the CPU 1004 controlling the power measurement cells 1008. The power measurement cells 1008 interface with each other using local interfacing buses 1010. An external host 1014 uses a common bus to interface 1012 with each power measurement cell 1008 separately and request status information from the power measurement cells 1008.

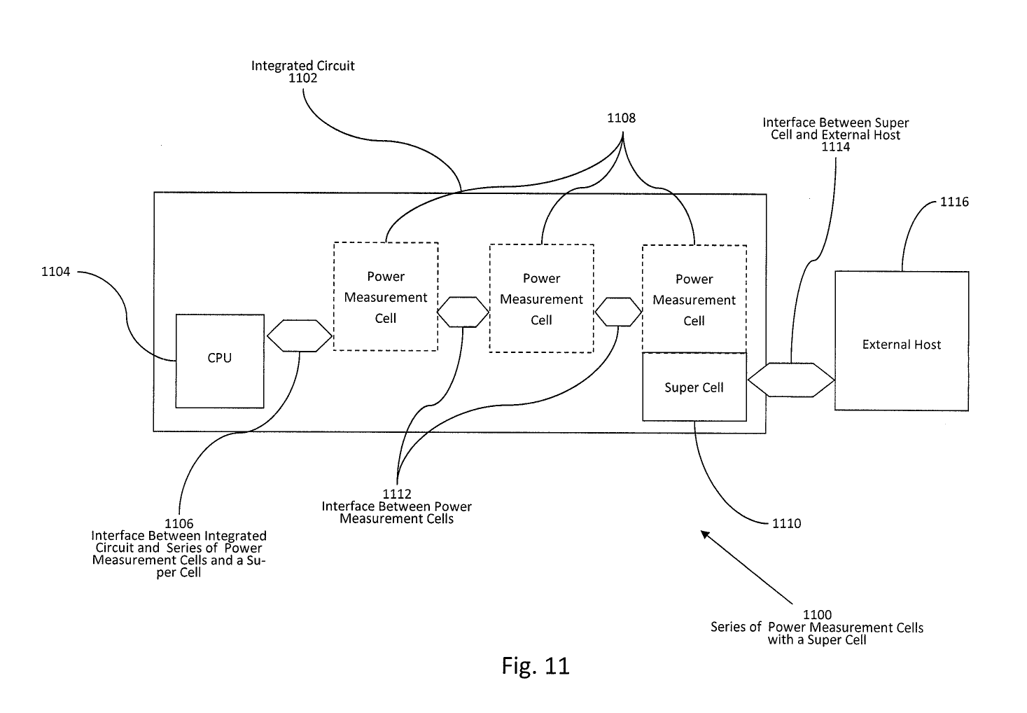

FIG. 11 is a diagram of a series of power measurement cells with a super cell 1100. As shown in FIG. 11, once the power measurement cells 1108 and super cell 1110 interface 1106 with the integrated circuit 1102 through the integrated circuit's CPU 1104, an external host 1116 is able to interface 1114 with the super cell 1110, where by example the external host 1116 is able to upload a monitoring program to the super cell 1110 in order to monitor multiple power planes or electrical signals. The program uploaded to the super cell 1110 allows the monitoring of the electrical signals of the integrated circuit 1102 without interruption of the performance of the integrated circuit's CPU 1104. The power measurement cells 1108 interface with each other using local interfacing buses 1112.

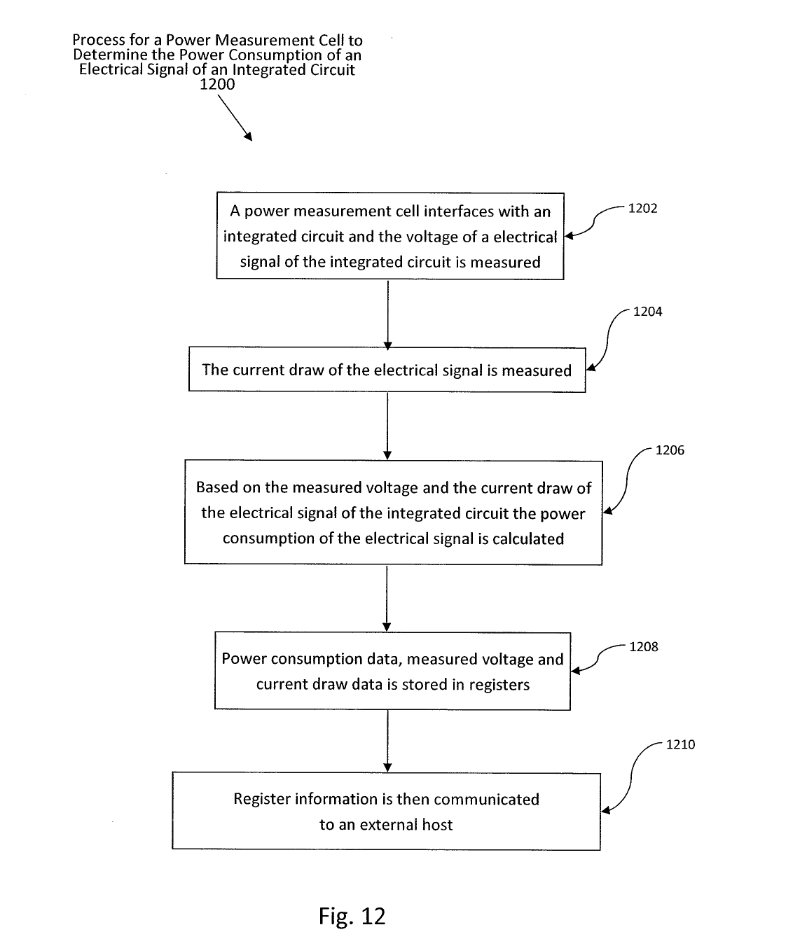

FIG. 12 is a flow diagram of a process for a power measurement cell to determine the power consumption of an electrical signal of an integrated circuit 1200. As shown in FIG. 12, at step 1202, a power measurement cell interfaces with an integrated circuit and the voltage of an electrical signal or power plane of the integrated circuit is measured and the measured voltage is stored in a measured voltage data register. At step 1204, the current draw of the electrical signal of the integrated circuit is measured and the measured current draw is stored in a current draw data register. At step 1206, based on the measured voltage and the measured current draw of the electrical signal, the power consumption of the electrical signal of the integrated circuit is determined using an arithmetic calculation and the data is stored in a consumption data register. At step 1208, power consumption data, measured voltage and the measured current draw is stored in data registers as register information, where the register information in the data registers can be sent and stored in a data buffer. At step 1210, the register information in the data buffer can be accessed through the data buffer by an external host through a cell interface or dedicated test and debug port.

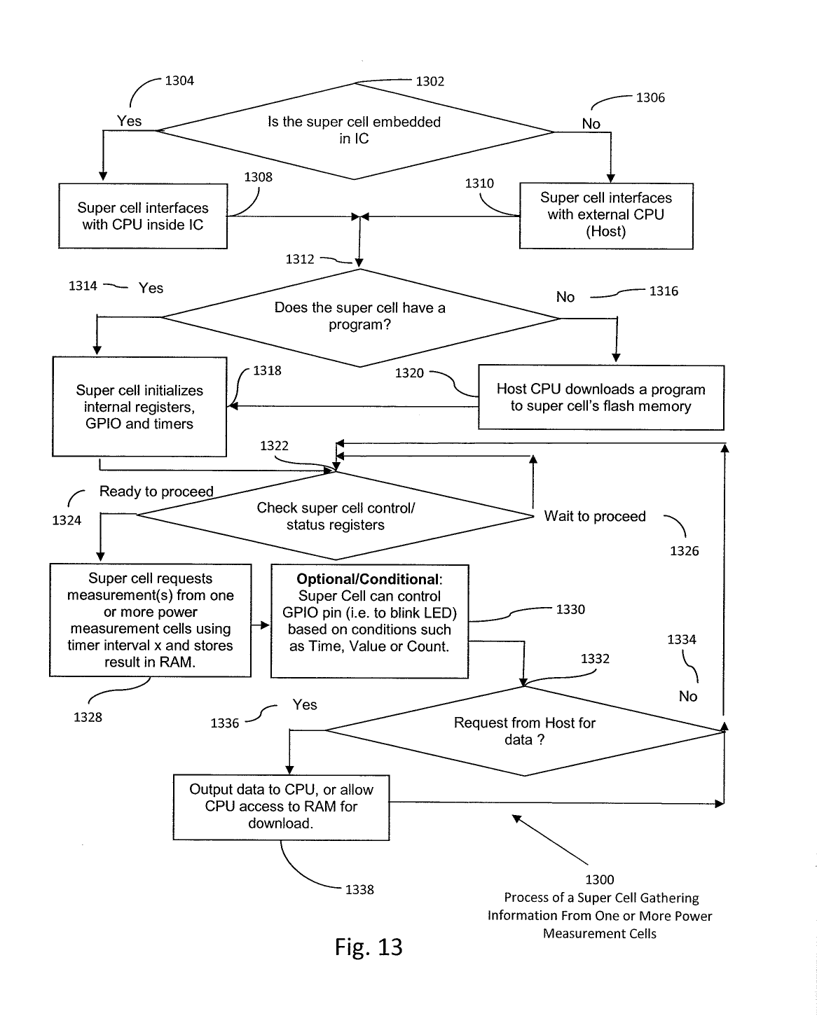

FIG. 13 is a flow diagram of the process of a super cell to gather information from one or more power measurement cells 1300. As shown in FIG. 13, at step 1302, a super cell is provided. At step 1304, it is determined if the super cell is embedded within an integrated circuit (“IC”). At step 1306, it is determine if the super cell is not embedded within an IC. At step 1308, if the super cell is embedded within the IC, then the super cell interfaces with a CPU within the IC. At step 1310, if the super cell is not embedded within the IC, then the super cell interfaces with the IC by means of an external host. At step 1312, the super cell is checked to see if a program has been uploaded into the flash memory. At step 1314, if the super cell does have an uploaded program, then the super cell proceeds to step 1318 and will initialize internal registers, GPIO and timers. At step 1316, if the super cell does not have an uploaded program, then the process proceeds to step 1320, where an external host downloads a program, such as a measurement program, to the super cell's flash memory and then the process proceeds to step 1318, where the super cell will initialize internal registers, GPIO and timers. At step 1322, the control and status registers of the super cell are checked to see if they are ready to proceed. At step 1324, if the control and status registers are ready to proceed, then the process will proceed to step 1328, at which time the super cell will request information from one or more power measurement cells, such as a measurement from one or more power measurement cells using time interval x and then stores the data in RAM. If the control and status registers are not ready to proceed to step 1324, then the process will proceed to step 1326, where the super cell will wait until the control and status registers of the super cell are ready to proceed to step 1328. At step 1330, as an optional feature, the super cell can control a GPIO pin (such as a blink LED) based on conditions such as time, value or count. At step 1332, the data stored in the RAM may be requested by an external host. At step 1336, if the data is requested by an external host, then the process proceeds to step 1338, where output data from the RAM is sent to a CPU or downloaded. At step 1334, if the data is not requested by an external host, the process proceeds back to step 1322, where the super cell begins the process again by checking the status of the control and status registers.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for the measurement of the power consumption of an electrical signal of an integrated circuit comprising:
connecting a first power measurement cell to said integrated circuit;
measuring a voltage of one electrical signal of said integrated circuit;
measuring a current draw of one electrical signal of said integrated circuit;
calculating said power consumption of said electrical signal of said integrated circuit; and
communicating said power consumption of said electrical signal of said integrated circuit to a host.

2. The method of claim 1, further comprising:
connecting one or more power measurement cells to said first power measurement cell;
connecting said one or more power measurement cells to said integrated circuit;
measuring a voltage of one or more electrical signals of said integrated circuit;
measuring a current draw of said one or more electrical signals of said integrated circuit;
calculating said power consumption of said one or more electrical signals of said integrated circuit; and
communicating said power consumption of said one or more electrical signals of said integrated circuit to said host.

3. The method of claim 1, further comprising:
connecting a super cell to said first power measurement cell; and
communicating a command from said super cell to said first power measurement cell.

4. The method of claim 3, wherein said command is for automated periodic monitoring of the power consumption of said electrical signal.

5. The method of claim 3, wherein said command is communicating with an external LED regarding the status of said first power measurement cell.

6. The method of claim 3, wherein said command is communicating with a timer block to periodically record data from said first power measurement cell.

7. The method of claim 3, wherein said command is communicated to two or more power measurement cells.

8. The method of claim 7, wherein said command from said super cell is the same command communicated to each said two or more power measurement cells.

9. The method of claim 7, wherein said command from said super cell to said two or more power measurement cells is a different command to each said two or more power measurement cells.

10. A power measurement cell for the measurement of the power consumption of an electrical signal of an integrated circuit comprising:
an internal interface bus that is connected to said integrated circuit;
a voltage logic cell that is connected to said electrical signal from said integrated circuit;
at least one data storage register that is connected to said voltage logic cell;
at least one control register that is connected to said voltage logic cell;
a current measurement cell that is connected to said electrical signal from said integrated circuit;
at least one data storage register that is connected to said current measurement cell;
a power calculation logic cell, wherein said power calculation logic cell is connected to said data storage register from said voltage logic cell and to said data storage register from said current measurement cell;
at least one data storage register that is connected to said power calculation logic cell; and
a data buffer that is connected to said at least one data storage register that is connected to said power calculation logic cell.

11. The power measurement cell of claim 10, wherein said power measurement cell is embedded within said integrated circuit.

12. The power measurement cell of claim 10, wherein said power measurement cell is located externally of said integrated circuit.

13. The power measurement cell of claim 10, wherein said power measuring cell interfaces with one or more power measurement cells, wherein said one or more power measurement cells comprise:
an internal interface bus that is connected to said integrated circuit;
a voltage logic cell that is connected to said electrical signal from said integrated circuit;
at least one data storage register that is connected to said voltage logic cell;
at least one control register that is connected to said voltage logic cell;
a current measurement cell that is connected to said electrical signal from said integrated circuit;
at least one data storage register that is connected to said current measurement cell;
a power calculation logic cell, wherein said power calculation logic cell is connected to said data storage register from said voltage logic cell and to said data storage register from said current measurement cell;
at least one data storage register that is connected to said power calculation logic cell; and
a data buffer that is connected to said at least one data storage register that is connected to said power calculation logic cell.

14. The power measurement cell of claim 10, wherein said power measurement cell interfaces with a super cell.

15. The super cell of claim 14, wherein said super cell comprises:
an internal interface bus connected to said power measurement cell;
a central processing unit connected to said internal interface bus;
a flash memory cell connected to said central processing unit;
a random access memory cell connected to said central processing unit and connected to said power measurement cell; and
a general purpose input/output block connected to said central processing unit and connected to said random access memory cell.

16. The super cell of claim 15, further comprising:
a timer coupled to said flash memory cell and said internal interface bus; and
one or more control registers connected to said timer and to said central processing unit.

17. The power measurement cell of claim 13, wherein said power measurement cell interfaces with a super cell.

18. The power measurement cell of claim 17, wherein said super cell comprises:
an internal interface bus connected to said power measurement cell;
a central processing unit connected to said internal interface bus;
a flash memory cell connected to said central processing unit;
a random access memory cell connected to said central processing unit and connected to said power measurement cell; and
a general purpose input/output block connected to said central processing unit and connected to said random access memory cell.

19. The super cell of claim 18, further comprising
a timer connected to said flash memory cell and said internal interface bus; and
one or more control registers connected to said timer and to said central processing unit.
